(19) United States
(12) Patent Application Publication
(10) Pub. No.: US 2004/0006157 A1
(43) Pub. Date: Jan. 8, 2004

(54) Ultra violet curable 100 percent solids inks

(76) Inventors: Daniel F. Gloster, Somerville, MA (US); Alethea C. Davis, Dorchester, MA (US); Michelle S. Morgan, Hudson, NH (US); Robert J. Anderson, Lowell, MA (US); Paul F. Doll, East Providence, RI (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/423,247

(22) Filed: Apr. 25, 2003

Related U.S. Application Data
(60) Provisional application No. 60/375,678, filed on Apr. 26, 2002.

(51) Int. Cl. C03C 17/00; C09D 5/00

(52) U.S. Cl. 523/160; 523/161

(57) ABSTRACT

The present invention provides a 100% solids Uv curable ink. A 100% solids Uv curable ink should emit substantially less VOCs than an organic solvent-based ink because the components of the solids ink are intended to become part of the Uv cured product. An ink for one embodiment of the present invention can comprise more than one resin, a photoinitiator, a carrier medium; and a colorant. Preferably the one polymerizable resin is a highly functional resin and another polymerizable resin is a low functional resin. One resin may be high viscosity and the other low viscosity. The ink could be suitable for use in a drop on demand print system such as with a piezoelectric printer.

Further, certain aspects of the invention provide a method for formulating an ink by combining a polymerizable resin, a photoinitiator, and a colorant in a carrier medium. Such an ink can be jetted onto a substrate and cured with ultra violet radiation. The jetting and curing of the ink can be caused by an ink jet printhead with an ultra violet lamp attached to the printhead. This lamp-printhead can be used in an ink jet printer. Other aspects of the present invention include a multicolor ink sets.

### REFERENCE TO RELATED APPLICATION

This application claims the benefit of and incorporates by reference U.S. application Ser. No. 60/375,678 filed Apr. 26, 2002 in its entirety.

### BACKGROUND OF THE INVENTION

Ink jet printing can be accomplished in several ways. One way is to charge an ink drop and then deflect the charged ink drop using an electric field. This is referred to as continuous ink jet printing. Another way to print with an ink jet is to cause ink to drop on demand. Drop on demand (DOD) printing can be accomplished at least in two ways. First, in thermal ink jet printing, a small bubble forms in an ink to thereby eject a tiny ink drop when the bubble bursts. A second way to use DOD printing is with a piezoelectric actuator that forces ink through a nozzle using pressure. Compared to continuous ink jet and thermal ink jet printing, piezoelectric ink jet printing generally allows for more flexibility in the variety of inks with which it can be used.

There are also a variety of inks suitable for use in ink jet printing. Some inks are water-based (aqueous), and some are based on organic solvents. An ink can also use a colorant such as a dye or pigment. Each type of ink has properties that make it more or less suitable for a particular use. In some cases, inks will smear when rubbed or when wetted, or fade when exposed to light. These undesirable properties can be affected, for example, by the particular solvent or the colorant used in the ink.

Attempts to overcome these and other related problems include the use of ultra violet (Uv) curable materials in an ink. In such a system, Uv light is used to cure a polymeric material in the ink after the ink is applied to a substrate. Uv curable inks may include aqueous inks described in U.S. Pat. No. 5,623,001 to Figov. Despite using Uv curable agents, aqueous and organic solvent-based inks can have issues that affect their proper usage. This may be attributable to the use of water as a solvent for organic compounds, or organic solvent-based inks that “de-gas” or emit volatile organic compounds (VOCs).

### SUMMARY OF THE INVENTION

The present invention provides a 100% solids Uv curable ink. A 100% solids Uv curable ink should emit substantially less VOCs than an organic solvent-based ink because the components of the solids ink are intended to become part of the Uv cured product.

Certain embodiments of the present invention provide an ultra violet radiation curable ink. An ink for one embodiment of the present invention can comprise more than one resin, a photoinitiator, a carrier medium; and a colorant. Preferably the one polymerizable resin is a highly functional resin and another polymerizable resin is a low functional resin. One resin may be high viscosity and the other low viscosity. The ink could be suitable for use in a drop on demand print system such as with a piezoelectric printer.

Certain components are preferred but not required to practice the present invention. A preferred photoinitiator is Darocur 4265 or a mixture of Igracure 907 and ITX. The colorant can be a dye or a pigment. Suitable carrier mediums include isooctylacrylate, 2-(2-ethoxyethoxy) ethylacrylate, or dipentanerytheritol pentaacrylate.

Further, certain aspects of the invention provide a method for formulating an ink by combining a polymerizable resin, a photoinitiator, and a colorant in a carrier medium. Such an ink can be jetted onto a substrate and cured with ultra violet radiation. The jetting and curing of the ink can be caused by an ink jet printhead with an ultra violet lamp attached to the printhead. This lamp-printhead can be used in an ink jet printer.

Other aspects of the present invention include a four color ink set cyan, magenta, yellow and black colorants. Ink sets can have at least 4, 6, 8, 12, 16 or more colors of inks. In certain embodiments, the colorant is a blend of dyes or pigments prepared to match a spot color.

### DETAILED DESCRIPTION

Certain terms used throughout this description are collected here for convenience. The term “drop on demand” refers to the dropping of an ink drop in response to pressure caused by an actuator. Although an ink may be suitable for drop on demand printing, inks of the present invention are not intended to be limited to solely such usage. The term ultra violet radiation curable (Uv curable) refers to a property of an ink that will undergo a polymeric type curing upon exposure to ultra violet radiation. The term “100% solids ink” refers to an ink where all or substantially all of the components of the ink become part of the cured ink. The use of such inks is desirable to avoid degassing or the emission of VOCs. Polymerizable resin generally means a resin with one or more functional groups that may polymerize under certain conditions. Colorants of the present invention include dyes and pigments. The terms ink jet cartridge, ink jet printer, ink jet printhead and piezo ink jet print head are known in the art.

Ultra violet (Uv) curable inks offers many advantages over traditional solvent ink jet printing. A Uv curing ink comprises polymerizable resins, colorants, stabilizers, photoinitiators, and other ink jet components that form a permanent image upon Uv irradiation. Unlike solvent-based inks, 100% solids Uv-cured prints should not emit noxious and combustible vapors. These inks are designed to produce stable and durable images upon Uv irradiation, a process that causes the ink components to polymerize forming a durable image. Polymerization can be initiated by one of or by a combination of cationic, anionic, and radical catalysis.

The process of polymerization of an ultra violet ink is begun when a photoinitiator is promoted to its excited state by absorbing a photon of ultra violet radiation. In certain inks of the present invention, the initiator then generates a radical species that begin a polymerization chain reaction. Initiation can proceed by Type 1 or 2 mechanisms. Type 1 initiation is a unimolecular process in which the initiator fragments upon irradiation to give two radicals. Bimolecular, Type 2 initiation, requires the interaction of two molecules. In general, one molecule readily achieves the excited state but would not readily initiate chain polymerization. However, this excited molecule can interact with another molecule to produce a radical that can efficiently promote polymerization. Addition of a radical to a monomer or oligomer begins the process by which an image is rendered permanent.

Resins

Resins can be mono, di, tri, tetra, and poly functional and each functional group can participate in polymerization. Consequently, strength, flexibility, and durability of a cured image is directly related to the degree of cross-linking. A high degree of cross-linking leads to a more rigid photocured image. In general, highly functional resins are highly viscous liquids that produce hard and durable cured images. Highly functional resins may shrink upon photocuring imparting brittleness to the image. Images formed by curing mono and di-functional resins are frequently neither durable nor rigid. Low functional resins can have viscosity values approaching that of water. A blend of both low and high functional resins is preferred to give inks with viscosities low enough to be jetted through an ink jet printer designed to print aqueous inks but with sufficient high functional high viscosity resin to produce an image that is hard and durable after Uv irradiation. In certain embodiments of the present invention, a Uv curable 100% solids ink can be jetted through a commercially available printer designed to print aqueous ink through Epson-style peizo printheads.

As mentioned earlier, highly functional resins increase the durability of a cure but typically have viscosity values far too high to be jetted through an ink jet printer. To solve this problem lower viscosity/lower functionality resins were blended with the higher functional resins.

A number of Uv curable resins can be incorporated into Uv curable inks. The following examples of resins suitable for use in the present invention illustrate the breadth of the invention which is not intended to be limited to the listed examples.

| | |
|---|---|
| SR-201 | allyl methacrylate |
| SR-203 | tetrahydrofurfuryl methacrylate |
| SR-206 | ethylene glycol demethacrylate |
| SR-212B | 1,3 butylene glycol diacrylate |
| SR-213 | 1,4 butane diol dimethacrylate |
| SR-238 | Urethane acrg,ate blended with tripropylene glycol |
| | diacetate |
| SR-256 | 2-(2-ethoxyethoxy) ethylacrylate |
| SR-259 | polyethylene glocol (200) diacrylate |
| SR-295 | pentanerytheritol tetraacrylate |
| SR-306 | tripropylene glycol diacetate |
| SR-313B | lauryl methacrylate |
| SR-335 | lauryl acrylate |
| SR-339 | 2-phenoxyethyl acrylate |
| SR-339A | proprietary (Sartomer) |
| SR-344 | polyethylene glocol (400) diacrylate |
| SR-355 | di-trimethylopropane tetraacrylate |
| SR-368 | tris-(2hydroxy ethyl) isocyanurate triacrylate |
| SR-395 | isodecyl acrylate |
| SR-399 | dipentanerytheritol pentaacrylate |
| SR-415 | ethoxylated (20) trimethylopropane triacrylate |
| SR-444 | pentanerythritol triacrylate |
| SR-4890 | proprietary (Sartomer) |
| SR-492 | propoxylated (3) trimethylopropane triacrylate |
| SR-493D | tridecyl methacrylate |
| SR-494 | ethoxylated (4) pentacrytheritol tetraacrylate |
| SR-506 | isobornyl acrylate |
| SR-508 | dipropylene glycol diacrylate |
| SR-9003 | propoxylated neopentyl glycol dicrylate |
| SR-9008 | alkoxylated trifunctionsal acrylate ester |
| SR-9011 | trifunctional methacrylate ester |
| SR-9012 | trifunctional acrylate ester |
| SR-9041 | pentaacrylate ester |
| SR-909 | proprietary (Sartomer) |
| SR-NTX-5249 | proprietary (Sartomer) |
| CD-550 | methoxy polyethylene glycol (350) monomethacrylate |
| CD-582 | alkoxylated cyclohexane dimentanol diacrylate |
| CD-611 | alkoxylated tetrahydrofurfuryl acrylate |
| CD-800 | proprietary (Sartomer) |
| CD-9042 | proprietary (Sartomer) |
| CD-9044 | proprietary (Sartomer) |
| CD-9051 | trifunctional acid ester |
| CD9052 | trifunctional acid ester |
| CD-9075 | proprietary (Sartomer) |
| CD-9088 | proprietary (Sartomer) |
| CN966A80 | Urethane acrylate blended with tripropylene glycol |
| | diacetate |
| CN963B80 | Urethane acrylate blended with Urethane acrg,ate |
| | blended with |
| | tripropylene glycol diacetate |
| CN985B88 | proprietary (Sartomer) |
| | urethane acrylate blended with ethoxylated (3) |
| | trimethylopropane |
| CN963E75 | triacrylate |
| | urethane acrylate blended with ethoxylated (3) |
| | trimethylopropane |
| CN982E75 | triacrylate |
| CN966R6O | urethane acrylate blended with ethoxylated (4) nonyl |
| | phenol acrylate |
| CN981B88 | urethane acrylate blended with 1,6-hexanediol |
| | diacrylate |
| CN966J75 | urethane acrylate blended with isobornyl acrylate |
| CN-371 | reactive amine coinitiator |
| CN-386 | reactive amine coinitiator |
| CN-372 | reactive amine coinitiator |
| CN-384 | reactive amine coinitiator |
| CN-383 | reactive amine coinitiator |
| CN-975 | hexafunctional urethae acrylate |
| CN-968 | urethane acrylate |
| CN-373 | reactive amine coinitiator |

Photomer resins (such as those by Cognis) can also be used in the inks of the present invention.

Photoinitiators

Photoinitiators are another component of Uv-curable inks. The initiator should be soluble in and compatible with the resins used in the inks and able to produce a complete and rapid cure upon photo-irradiation. Routine testing can determine the minimum amount of initiator necessary to (1) keep the different colors from bleeding into each other and (2) completely cure the jetted image. Preferred initiators include Igracure 500, Igracure 907, Darocur 4265, and ITX (sensitizer-isopropyl 9H thioxanthene-9-one).

Uv Curing

Uv light or radiation is usually applied to an ink on a substrate to cause curing in certain embodiments of the present invention. For example, a Uv lamp and conveyor system, an electrodeless system, as well as fixed and pulsed xenon lamps can be used to cure inks of the present invention. A lamp can be attached to the printhead so that the image can be tacked and cured as quickly as possible. It is preferable to limit the weight that is appended to a printhead. Preferably, the lamp should not exceed ten ounces. Any commercially available lamp system can be used. A continuous xenon lamp system (Xenon Corp. of Woburn, Mass.) was attached to the printhead and to both pin and cure the jetted image.

Pigment Dispersions

Pigments are insoluble colored species that have had their surface treated so that they can be dispersed into a carrier medium. If pigment dispersion separates at room temperature, the stability of the pigment dispersion can be improved in a number of ways. A different carrier medium can be used or the pigment is treated with surfactants or like molecules. The treatment can be covalent, electrostatic, or both. These surfactants impart solubility to the insoluble pigment particles

Carrier Medium

Any suitable carrier medium can be used. A preferred carrier medium is isooctyl acrylate (SR-440 Sartomer). Typically the pigments are ground into a low viscosity resin. Other suitable resins for grinding include 2-(2-ethoxyethoxy) ethylacrylate (SR-256) and dipentanerytheritol pentaacrylate (SR-399).

Ink Properties

Preferably, the physical parameters of a Uv ink should be similar to those of the aqueous inks that were designed for the printer. The viscosity of the ink should be low, both the dynamic and static surface tension should be moderately low, the ink must be stable over time, the ink should cure quickly, the cured image should be photostable and durable, and the particle size of the pigment dispersion should be on the order of microns, more particularly about less than 200 microns. A preferred particle size is about 2.0 microns or less, more preferably below about 1.0 micron and especially below about 0.5 microns.

Images have been printed and cured images using these inks with a peizo printer. Listed below is a very general description of some of the experiments that led to the formulations listed above. The following specific examples are not intended to limit the scope of the invention as understood the entire description and claimed in the claims which follow.

### EXAMPLE 1

Uv-Curable Aqueous Inks

Uv-curable aqueous inks were prepared in accordance with the following table.

Wt. Grams

| | Ink A | Ink B |
|---|---|---|
| Water | 47 | 47 |
| GXL (biocide) | 0.2 | 0.2 |
| Igracure 2959 | 3 | 3 |
| RCC-13-691 (Cognis) | 20 | — |
| SR-415 | — | 20 |
| Tricon DY 132 | — | 30 |
| C & K Magenta | 30 | — |

Both inks A and B were cured with short wave irradiation from a lamp designed to visualize thin layer chromatography. Ink A produced a better cure than ink B. Ink B was not very rub fast.

### EXAMPLE 2

Uv Curable Aqueous Four Color Ink Set

A four color Uv-curable ink set was formulated in accordance with the following table.

Formulation by weight (grams)

| | Ink A | Ink B | Ink C | Ink D |
|---|---|---|---|---|
| Water | 46.8 | 46.8 | 46.8 | 46.8 |
| GXL (biocide) | 0.2 | 0.2 | 0.2 | 0.2 |
| Igracure 2959 | 3 | 3 | 3 | 3 |
| RCC-13-691 (Cognis) | 20 | 20 | 20 | 20 |
| Duasyn Cyan | 30 | — | — | — |
| C & K Magenta | — | 30 | — | — |
| Tricon DY 132 | — | — | 30 | — |
| Special Black | — | — | — | 30 |

The inks were drawn down onto the back side of glossy media and then cut in half to provide control and experimental strips. The experimental strips were cured by short wave irradiation from a TLC visualization lamp. The cured samples were rub fast but not water fast. The control samples were neither rub nor water fast. SR 9035 has poor water solubility and did show some resistance to water when cured. The following table summarizes certain solubility results.

Solubility

| | | | | | Water + 1,5 |
|---|---|---|---|---|---|
| | | Water + 1,5 | | SR 415 + | Pentane diol + |
| | Water | Pentane diol | SR 415 | Water | SR 415 |
| RCC-13- | Poor | Poor | Soluble | Insoluble | Soluble |
| 215 | | | | | |
| RCC-13- | Poor | Poor | Soluble | Insoluble | Slightly |
| 361 | | | | | Soluble |
| Photomer | Poor | Poor | Soluble | Insoluble | Soluble |
| 4025 | | | | | |
| Photomer | Poor | Soluble | Soluble | Insoluble | Soluble |
| 4158 | | | | | |
| Photomer | Poor | Soluble | Soluble | Insoluble | Slightly |
| 4155 | | | | | Soluble |

By mixing RCC 13-691 with SR 399, Igracure 2959, water, isopropanol, and C & K magenta, a water and rubfast Uv-coat was formulated.

A preferred formulation comprises RCC-13-691 and SR 399, 2-butanol, Igracur 2959, and C & K dye. As, summarized in the following table, an optimal ratio of RCC- 13-691 to SR 399 was determined.

| | Ink A | Ink B | Ink C | Ink D | Ink E | Viscosity |
|---|---|---|---|---|---|---|
| RCC-13-691 | 15 | 15 | 15 | 15 | 15 | 55 |
| SR 399 | 5 | 10 | 15 | 20 | 25 | 84 |
| 2-butanol | 10 | 10 | 10 | 10 | 10 | |
| Igracur 2959 | 1.5 | 1.5 | 1.5 | 1.5 | 1.5 | |
| C & K magenta | 1.5 | 1.5 | 1.5 | 1.5 | 1.5 | |

These inks were evaluated based upon general appearance, dry rub, wet rub, cracking, and cure speed. Ink A, followed by ink B, was the best ink.

### EXAMPLE 3

Uv Curing

A powerful Uv curing device improved the performance of the inks. A Fusion 200 Uv lamp with conveyor system (BetaCare Technologies) was connected to an ink jet printer. The lamp included a D, an H, and a V bulb. The letter codes D, H and V refer to long wavelength Uv, short wavelenght Uv, and light emission with Uv and visible radiation, respectively. Original work was conducted with the H bulb.

It is important to use colorants that resist fading upon Uv-curing. As summarized in the following table, a large array of inks were formulated using a general recipe. The inks comprise resin-0.5 grams, darocur 1173, 2-butanol-2.0 grams, and savinol blue gls-0.02 grams. The fading of inks upon Uv-curing is noted in the table. Faster or slower conveyer speeds may be used to decrease or increase, respectively, the time the ink is exposed to Uv radiation.

| | Vernon ERC | | | | | Vernon Matte | | | | | Vernon Polish | | | | |
|---|---|---|---|---|---|---|---|---|---|---|---|---|---|---|---|
| Fusion 200—5H | Conveyor | Conveyor | Dry | Wet | | Conveyor | Conveyor | Dry | Wet | | Conveyor | Conveyor | Dry | Wet | |
| 2708 Bulb | Speed 50 | Speed 80 | Rub | Rub | | Speed 50 | Speed 80 | Rub | Rub | | Speed 50 | Speed 80 | Rub | Rub | |
| RCC-13-215 | F | | | | | F | | | | | F | | | | |
| Photomer 3691 | | F | | | | | F | | | | | F | | | |
| RCC-13-361 | | OK | No | Yes | | | OK | No | No | | | OK | No | No | |
| RCC-13-429 | | F | Yes | Yes | | | MF | Yes | Yes | | | MF | Yes | Yes | |
| Photomer 4025 | | F | Yes | | | | F | Yes | | | | F | Yes | | |
| Photomer 4155 | | OK | Yes | Yes | | | F | Yes | No | | | F | Yes | No | |
| Photomer 4158 | | F | Yes | Yes | | | F | No | | | | F | No | | |
| Photomer 4812 | | OK | | | IC | | OK | | | IC | | OK | | | IC |
| Photomer 4816 | | OK | | | IC | | OK | | | IC | | OK | | | IC |
| Photomer 6230 | | MF | Yes | Yes | | | MF | Yes | Yes | | | F | Yes | | |
| Photomer 3691 | | | | | | | | | | | | | | | |
| Sartomer CD 550 | | F | No | | | | F | No | | | | F | No | | |
| Sartomer 344 | | F | Yes | Yes | | | F | No | | | | F | No | | |
| Sartomer 604 | | MF | | | IC | | MF | | | IC | | F | | | IC |
| Photomer 4226 | | OK | Yes | Yes | | | MF | Yes | No | | | F | Yes | No | |
| Sartomer 415 | | F | Yes | | | | F | No | | | | F | No | | |
| Sartomer 9035 | | F | Yes | | | | F | Yes | | | | F | Yes | | |
| Sartomer 9038 | | F | Yes | No | | | F | No | | | | F | No | | |
| Sartomer 368 | | F | Yes | Yes | | | MF | No | Yes | | | MF | No | Yes | |
| Sartomer 399 | | F | Yes | Yes | | | F | Yes | Yes | | | F | Yes | Yes | |
| Sartomer 288 | | MF | Yes | Yes | | | MF | No | | | | MF | No | | |
| Sartomer 259 | | F | Yes | Yes | | | F | Yes | No | | | F | No | No | |
| TEGDVE | | F | Yes | Yes | | | F | Yes | Yes | | | F | No | | |
| 4-HBVE | | F | Yes | | | | F | Yes | | | | F | No | | |
| Vinyl Caprolactam | | F | Yes | Yes | | | F | Yes | Yes | | | Ok | Yes | Yes | |
| Fave 4101 | | OK | | | IC | | OK | | | IC | | OK | | | IC |
| Fave 4102 | | OK | | | IC | | OK | | | IC | | OK | | | IC |

| | Bruin Satin | | | | | Bruin | | | | |
|---|---|---|---|---|---|---|---|---|---|---|
| Fusion 200—5H | Conveyor | Conveyor | Dry | Wet | | Conveyor | Conveyor | Dry | Wet | |
| 2708 Bulb | Speed 50 | Speed 80 | Rub | Rub | | Speed 50 | Speed 80 | Rub | Rub | |
| RCC-13-215 | F | | | | | F | F | | | |
| Photomer 3691 | | F | | | | | F | | | |
| RCC-13-361 | | OK | No | No | | | OK | No | No | |
| RCC-13-429 | | F | Yes | Yes | | | F | Yes | Yes | |
| Photomer 4025 | | F | Yes | | | | F | Yes | | |
| Photomer 4155 | | F | Yes | | | | F | Yes | | |
| Photomer 4158 | | F | No | | | | F | No | | |
| Photomer 4812 | | MF | | | IC | | MF | | | IC |
| Photomer 4816 | | MF | | | IC | | MF | | | IC |
| Photomer 6230 | | F | Yes | | | | F | Yes | | |
| Photomer 3691 | | | | | | | | | | |
| Sartomer CD 550 | | F | No | | | | F | No | | |
| Sartomer 344 | | F | No | | | | F | No | | |
| Sartomer 604 | | F | | | IC | | F | | | IC |
| Photomer 4226 | | F | Yes | Yes | | | F | Yes | Yes | |
| Sartomer 415 | | F | No | | | | F | No | | |
| Sartomer 9035 | | F | Yes | | | | F | Yes | | |
| Sartomer 9038 | | F | No | | | | F | No | | |
| Sartomer 368 | | F | No | | | | F | No | | |
| Sartomer 399 | | F | Yes | Yes | | | F | Yes | Yes | |
| Sartomer 288 | | F | No | | | | F | No | | |
| Sartomer 259 | | F | Yes | No | | | F | Yes | No | |
| TEGDVE | | F | No | | | | F | No | | |
| 4-HBVE | | F | No | | | | F | No | | |
| Vinyl Caprolactam | | MF | Yes | Yes | | | F | Yes | Yes | |
| Fave 4101 | | OK | | | IC | | OK | | | IC |
| Fave 4102 | | OK | | | IC | | OK | | | IC |

F = Fade
MF = Medium Fade
IC = Incomplete Cure
Wet and Dry rub fast = Yes
Not Wet and Dry rub fast = No

The fading characteristics of resin soluble dyes are summarized in the following table.

Conveyor speed = 80 H Bulb

| Dye | Photomer 3691 | Sartomer 399 |
|---|---|---|
| Savinyl Pink 6 BLS | Complete Fade | Minimal Fade |
| Savinyl Red 3 BLS | Complete Fade | Medium Fade |
| Macrolex Red G | Complete Fade | Complete Fade |
| Savinyl Yellow RLS | Complete Fade | Minimal Fade |
| Nigrosin Base BA | Minimal Fade | Complete Fade |
| Savinyl Black NS | Complete Fade | Minimal Fade |

Inks that utilize cationic initiators were formulated as a 100% solids four color ink set as indicated by the following table.

| | Ink A | Ink B | Ink C | Ink D |
|---|---|---|---|---|
| 2-hydroxybutyl vinyl ether | 4.5 | — | — | 4.5 |
| triethyleneglycol divinyl ether | — | 4.5 | — | — |
| 1-vinyl-2-pyrrolidone | — | — | — | — |
| Darocur 1173 | 0.25 | 0.25 | 0.25 | 0.25 |
| Sartomer KI 85 | — | — | — | 0.25 |
| Savinyl Pink 6BLS | 0.05 | 0.05 | 0.05 | 0.05 |

All the components of 100% solids should become part of the Uv-cured product. Inks of this nature should avoid the degassing problems associated with organic solvent type inks.

### EXAMPLE 4

100% Solids Uv Curable Pigment Inks

Dye based Uv prints can fade when exposed to Xenon irradiation in a Weatherometer. In order to decrease fading possibly associated with dyes, pigments were used in a 100% solids ink. Although certain pigment dispersions may not be soluble in certain ink formulations, the solubility of pigments can be adjusted in a number of ways known in the art. For example, a different carrier medium in which the dispersion would have improved solubility can be selected. Additionally, a pigment can be treated with a surfactant to improve its solubility.

A number of pigment dispersions (PennColor dispersions) were used in 100% solids Uv curable ink formulations. All of the tested colors showed very little fade upon Uv curing and testing in a Weatherometer. Preferred Uv curable 100% solid ink formulations that were fade resistant after curing are listed below.

| | grams | grams | grams | grams |
|---|---|---|---|---|
| | (cyan) | (magenta) | (yellow) | (black) |
| Sartomer CN 386 | | | | 10 |
| Darocur 4265 | 18 | | | |
| Igracure 500 | 12 | | | |
| Igracure 907 | | 27 | 18 | 27 |
| ITX (isopropyl 9H thioxanthene- | | 3 | 2 | 3 |
| 9 one) | | | | |
| Sartomer SR 212B | | 74 | 120 | 39.2 |
| Sartomer SR 295 | 50 | | | |
| Sartomer SR 440 | 102 | | | |
| PennColor Dispersion 9S678 | 18 | 66 | 36 | 90.8 |
| PennColor Dispersion 9R715 | | 30 | | |
| PennColor Dispersion 9Y686 | | | 24 | |
| PennColor Dispersion 9B732 | | | | 30 |

The claimed invention is:

1. An ultra violet radiation curable ink comprising
a first polymerizable resin and a second polymerizable resin;
a photoinitiator;
a carrier medium; and
a colorant.

2. The ink of claim 1, wherein the first polymerizable resin is a highly functional resin.

3. The ink of claim 1, wherein the second polymerizable resin is a low functional resin.

4. The ink of claim 1, wherein the polymerizable resin is a high vicosity resin.

5. The ink of claim 1, wherein the polymerizable resin is a low viscosity resin.

6. The ink of claim 1, wherein the photoinitiator is Darocur 4265.

7. The ink of claim 1, wherein the photoinitiator is a mixture of Igracure 907 and ITX.

8. The ink of claim 1, wherein the colorant is a dye.

9. The ink of claim 1, wherein the colorant is a pigment.

10. The ink of claim 1, wherein the carrier medium is isooctylacrylate, 2-(2-ethoxyethoxy) ethylacrylate, or dipentanerytheritol pentaacrylate.

11. A method for formulating an ink of claim 10, wherein the ink is formulated by combining a polymerizable resin, a photoinitiator, and a colorant in a carrier medium.

12. A method for printing an image comprising
jetting an ink of claim 10 on substrate and
curing the ink with ultra violet radiation.

13. An ink jet printhead having an ultra violet lamp attached to the printhead.

14. An ink jet printer comprising the ink jet print head of claim 13 in the printer.
